(19) United States
(12) Patent Application Publication
(10) Pub. No.: US 2021/0062447 A1
(43) Pub. Date: Mar. 4, 2021

(54) PASSIVE TAILINGS COMPACTOR

(71) Applicant: PATRICK BROWN TECHNOLOGIES INC., Newcastle (CA)

(72) Inventor: DOUG ROY BROWN, LONDON, Ontario (CA)

(21) Appl. No.: 16/963,646

(22) PCT Filed: Jan. 22, 2019
(86) PCT No.: PCT/CA2019/050017

§ 371 Date: Jul. 21, 2020

(30) Foreign Application Priority Data
Jan. 22, 2018 (CA) 2992463

(51) Int. Cl. E02D 3/10

(52) U.S. Cl. CPC E02D 3/103; E02D 2600/30; E02D 2300/0085; E02D 2300/0051

(57) ABSTRACT

The Passive Tailings Compactor is a system of components for facilitating the continuous passive drainage and consolidation of fine-grained sediments in active and continuous deposition environments. The invention consists of a flotation device, an anchor mass, and a drainage conduit which acts as a tether between the flotation device and the anchor. The flotation device also serves to orient the drainage conduit horizontally. As water or sediment levels rise, the flotation device rotates, releasing drainage conduit wrapped around its axis. This allows the flotation device to move upwards, extending the drainage conduit passively. The flotation device uses asymmetrical fixed weights to resist lesser rotational forces. The drainage conduit serves to create a path of relatively high hydraulic conductivity, protected by a filter barrier, for the dissipation of pore pressures and consolidation of buried sediments. The anchor mass fixes the system in place.

### TECHNICAL FIELD

Mineral processing (mining) and other industries often generate waste products in the form of continuously-produced fine-grained mineral sediments with high moisture contents. These sediments (tailings) create large volumes of materials which often have low hydraulic conductivities due to their fine particle size and high water contents as a result of their deposition via hydraulic transport. These materials are typically stored in large basins, behind earthen dams or dykes, which are constructed at significant cost. When these materials are deposited with increasing vertical depth, the result is often a mass of material containing excess interstitial water (water between solid particles of mineral) with a limited ability to drain itself. This trapped interstitial water results in inefficiencies due to the additional waste storage volume it occupies and the inability to reuse any of this trapped process water. Geotechnical stability risks related to storage basins are also increased as a result of the reduced stability of fine-grained materials with high water contents and associated liquefaction potential. The positive impacts of increasing the drainage and consolidation of these sediments are:
Increased storage efficiency resulting from the release of interstitial pore water that would have otherwise required costly containment facilities. Increasing the density of the materials stored can dramatically reduce the cost and size of waste storage facilities required. Reduced waste facility size also results in reduced technical risks related to geotechnical stability.
Relatively improved geotechnical properties of the sediment material bulk mass due to reduced water content and higher consolidation which typically improves strength.
A reduced need for water for sustaining mineral processing operations (less water is lost to pore spaces, reducing the amount to be replaced from other environmental sources).
In some situations, a reduction in processing reagents will result as more water with entrained reagents and potentially valuable dissolved products like gold are returned to the process facility for further use or recovery.
Reduced long-term environmental risks related to the gradual draining and settlement of fine-grained sediments and the related release of potentially problematic interstitial water. This slow settlement can be problematic for timely reclamation and closure of tailings facilities.

### BACKGROUND ART

Drainage of fine-grained sediments is an established science frequently applied for the purpose of improving the geotechnical stability of soils and other materials prior to infrastructure construction activities. Fine-grained materials with high water contents often demonstrate low hydraulic conductivities and poor geotechnical strength parameters. Low hydraulic conductivity also impacts the geotechnical properties of the material when external forces are applied and interstitial water becomes pressurized. This typically results in a further reduction in geotechnical stability and strength (examples of such external forces are construction loads or seismic loads). The pressurization of pore water can result under certain circumstances in the liquefaction of a material occurring, with a resulting catastrophic loss in material strength.

Fine-grained sediments created by the mineral processing (mining) and other industrial sectors often are generated at a high volumetric rate which is not conducive to large-scale dewatering from an economic standpoint. The result is that many such waste storage facilities rely exclusively on gravity settling of bulk materials subsequent to deposition. The materials are frequently transported via hydraulic means in pipes prior to deposition, resulting in high moisture contents. Due to the low hydraulic conductivities and fine particle sizes often exhibited by these materials, settlement and dewatering is often very slow and cannot effectively occur before the material is trapped beneath subsequent layers of deposition (these problems are further exacerbated by material grain size segregation occurring within storage facilities).

Waste storage facilities (tailings ponds) are also highly inaccessible from the perspective of installing conventional soil dewatering technologies like pre-fabricated vertical wick drains which are drilled or pushed into the sediments from surface, as described in U.S. Pat. No. 5,213,449A. Waste storage facilities during operation typically have very poor surface stability conditions unsuitable for most heavy equipment or personnel access. This is a result of the continuous deposition environment where highly fluid materials are continuously being deposited until the facility ceases production. Downward-installed drains require either stable working surfaces or complex platform/barge systems which are generally either highly expensive or impractical during operating periods. Subsequent to deposition periods, downward installed wick drains provide less economic incentive to invest, as the facility is no longer operating and generating revenue. Downward-drilled wick drains also only impact the dewatering of existing sediments, as the discharge points of the drains would be quickly buried in typical mineral processing environments, causing them to cease functioning, and providing no benefits for the dewatering of subsequently-deposited sediments.

Some industrial facilities utilize mechanical processes to remove excess water from mineral sediment products, but these processes are currently applied prior to the sediment material being deposited in its final storage location. Examples of existing technology include pressurized filter presses and hydraulic cyclones for material dewatering. These processes are energy and infrastructure intensive, with complex logistical challenges and as such have only infrequently and in specific circumstances been adopted by large-scale mineral processing operations.

### DISCLOSURE OF INVENTION

The invention is described as a passive tailings compactor. This invention provides a low-cost, low-energy solution to the challenge of continuously removing excess interstitial water from fine-grained sedimentary materials in an active deposition environment. The invention allows for the accelerated compaction of fine grained materials by providing vertically-oriented drainage conduits of relatively higher hydraulic conductivity within a mass of fine-grained sediments. These conduits allow for gravitational forces to compact the sediments by causing the heavier mineral particles to displace interstitial water into the drainage conduits, where the water is transported to an area of lower pressure (typically upwards toward the supernatant pond or surface). The drainage conduits are positioned as a part of a network of many passive tailings compactor systems which are spaced depending upon the hydrological properties of the material being drained, deposition rate, and the desired speed of consolidation. This network of conduits serves to effectively increase the bulk hydraulic conductivity of the material being drained which allows it to consolidate more rapidly than possible in its untreated state.

The invention is a system comprised of three primary components: a bottom anchor mass; a flotation device which serves to anchor the system horizontally from the top while controlling the vertical extension of the system upwards; and a drainage conduit which connects from the bottom anchor to the top flotation device. The flotation device is also used to store drainage conduit required for future vertical extensions of the sediment basin. This conduit is wrapped around a central axis on the flotation device (effectively a spool). The flotation device is rounded to facilitate low-friction rotation around its axis when sitting on top of either water or sediments, allowing it to release additional drainage conduit as the depth of the sediment or water basin increases. This rotation is further controlled by asymmetrically weighting the flotation device to create an effective moment arm around the rotational axis when upsetting rotational forces are applied (such as wind shear or tension on the drainage conduit caused by increases in pond elevation lifting the flotation device). This increases the magnitude of the rotational force required to cause the device to rotate around its axis, helping to prevent the un-intended release of drainage conduit from the spool due to reasons other than an increase in the elevation of flotation device (such as the wind). The positive relative buoyancy of the flotation device compared to either water or mineral sediments generates a large upward force on the device when pond or sediment elevations increase as a result of sediment deposition, and due to the connection of the drainage conduit from the flotation device to the bottom anchor, the device is caused to rotate around its axis, releasing additional conduit and extending the vertical height of the system upwards. In this manner the device can extend upwards until drainage conduit is exhausted. At that point, additional drainage conduit can be connected into the system using a splice, and the vertical extension range is increased. Alternatively the flotation devices can be removed when drainage conduit length is exhausted, or simply left in place and buried or submerged by increasing sediment/pond elevations if desired. This is likely to be the case when a sediment storage facility (tailings pond) nears the end of its operational life and is prepared for closure.

The invention is novel due to its ability to function continuously in its purpose of providing drainage pathways through thick layers of sediments which have been and continue to be continuously deposited around the system in place. It achieves this purpose through its ability to extend vertically in tandem with the water/sediment level in the basin as the basin increases in vertical depth, all while continuing to provide un-broken drainage conduits through the entire vertical section of sediments. This invention allows all levels of sediments (deep through to shallow) to continuously drain and consolidate by connecting them hydraulically through a vertical conduit of relatively high hydraulic conductivity to the surface or a supernatant pond (providing a pathway of release) without interrupting the continued operation of further sediment deposition.

The invention can be installed either prior to deposition in a new facility, or in an active deposition environment from boats, amphibious machines, or helicopters depending on the characteristics and accessibility the containment facility in question. Installing the system requires only for the system to be dropped into the desired location in such a manner that the flotation device is free to rotate, releasing drainage conduit as the anchor sinks and/or the pond level rises over time. Installation is rapid and can be achieved with minimal cost in labour and specialized equipment (most facilities can effectively use small boats). Subsequent to installation, during the course of continuing operations of the sediment storage facility (tailings pond), the network of passive tailings compactors should not require additional modification, energy input, or adjustment, and as such do not present risks and costs associated with repeatedly accessing the interior of the sediment impoundment facility, which can be significant. This invention solves these logistical challenges while providing all the benefits and more of conventional sediment drainage technologies by way of its continuous operation: typical drainage technologies are installed once and treat previously-deposited sediments only, providing no benefit in terms of dewatering subsequently deposited materials.

### BRIEF DESCRIPTION OF DRAWINGS

FIG. 1: Isometric view of passive tailings compactor system in operation with a cut-away showing the asymmetrical mass contained within the flotation device.

FIG. 2: Detailed cross section of an example drainage conduit's components and function

FIG. 3: Front plan view of passive tailings compactor system with half displayed as a cross section (object is symmetrical)

FIG. 4: Side view showing passive tailings compactor system floating on supernatant water above multiple layers of deposited mineral sediments (tailings) being drained and compressed. Two different sections are displayed: the asymmetrical mass inside of the flotation device, which generates a torque resisting the unwinding of drainage conduit from the flotation device spool, and a section through the spindle showing the drainage conduit wrapped for storage.

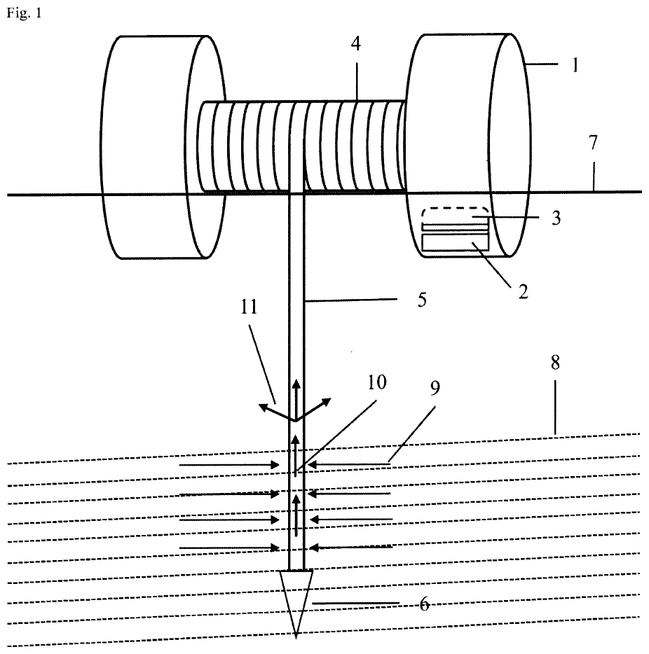

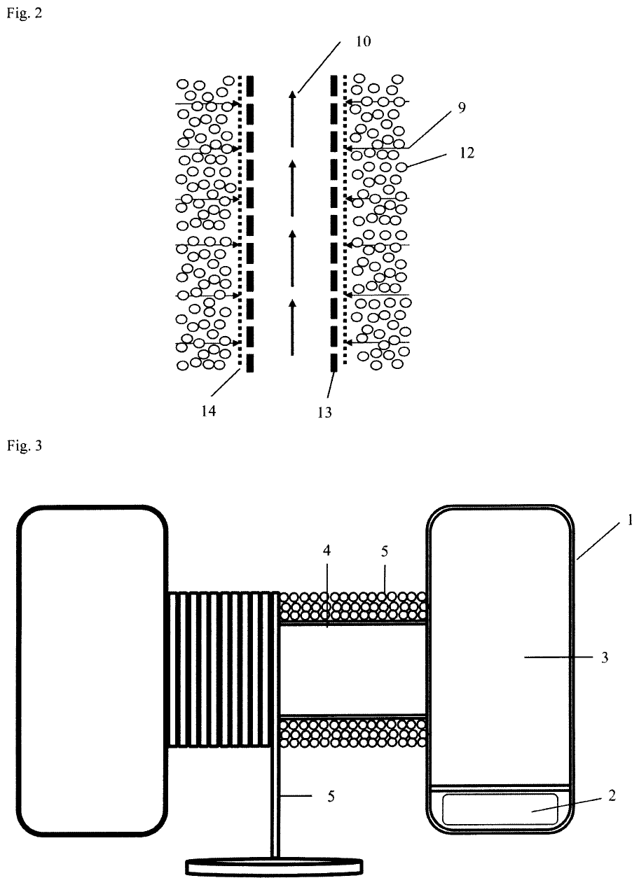

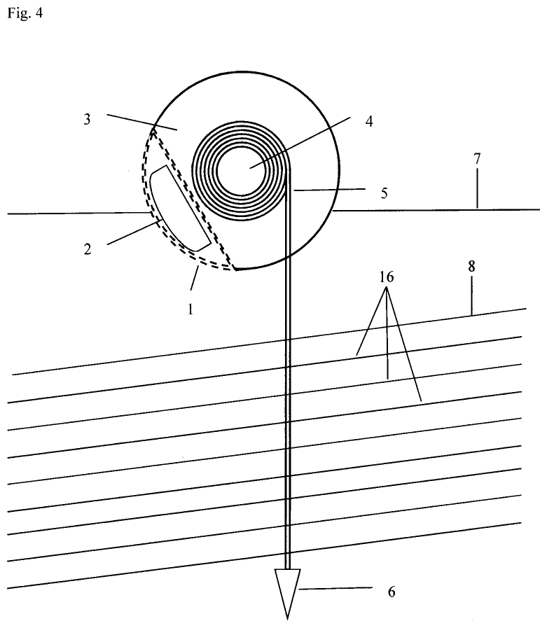

### BEST MODE FOR CARRYING OUT INVENTION

A system of components which facilitates the continuous release of trapped interstitial water from fine-grained sediments being actively deposited 16 in a containment facility (tailings storage facility) by creating a network of vertical drainage pathways in the sediment materials which are continuously extended upwards in tandem with pond or sediment elevation increases, connecting the surface or supernatant pond to all sediment horizons via a drainage pathway of relatively high hydraulic conductivity. The invention allows for the benefits of sediment consolidation and dewatering to be realized during the continued operation of a facility, and not only after the facility has completed operations and is preparing for remediation. The system is comprised of three primary components: a flotation device, an anchor mass, and a drainage conduit connecting the previous two components. The system extends upwards passively as the depth of sediment and or water increases. A description of each component and its purpose is provided:
a. Anchor Mass: A weight of high specific gravity or cross-sectional area which provides an anchor to the system, holding the base of the drainage conduit 5 fixed in location in three dimensions. This weight would be heavy and sharply shaped 6 to penetrate existing soft or unconsolidated sediments in operating facilities, facilitating the extension of the drainage system into previously-deposited sediments. It can also be lighter and shaped to provide a large cross-sectional area which would resist being pulled through fine sediments, effectively anchoring the system with less anchor material 15.
b. Flotation Device: A device which serves firstly to allow for the passive vertical extension of the passive tailings compactor system (by floating on top of supernatant water 7 or sediments 8), secondly to vertically orient the system, and thirdly to store drainage conduit 5 required for future vertical extensions of the system. Maintaining the shortest possible distance from anchor to floatation device is an important function of the flotation device, as it allows for dense networks of these passive tailings compactor systems to be place closely together without tangling. The flotation device would be of similar shape and design specifications to the marker buoy for fishing and navigational purposes described by Rovner in U.S. Pat. No. 3,653,085-A granted on May 7, 1970. Specific functionalities and characteristics include:
   i. The flotation device is essentially a spool constructed in a shape which results in high relative buoyancy (by creating hollow air pockets 3) or of a material which is inherently buoyant in water and/or mineral sediments. The flotation device is required to have a high chemical stability in water, under continuous exposure to sunlight, and potentially in harsh and unique chemical environments for long time periods (years). A suitable material could be cast high-density polyethylene plastic 1 shaped to create trapped air pockets 3 that increase the buoyancy of the device. Materials and size for this component could be modified for each unique environment.
   ii. The flotation device serves as a spool around its central axis 4. Drainage conduit 5 is wrapped around this spool for storage prior to being deployed. The flotation device rotates around this axis as the device's high relative buoyancy (as compared to water or mineral sediments) results in upward movement and a rotational force on the device caused by the anchor component and connected drainage conduit generating a torque around the axis of the spool 4. In this manner the drainage conduit is extended upwards as sediment 8 or water 7 levels, through continued deposition of sediment slurries 16, increase in elevation and the flotation device rotates around its central axis releasing more drainage conduit.
   iii. The flotation device 1 is round and smooth in the dimension perpendicular to the rotational axis in order to reduce frictional forces which might resist the rotation of the device around its central axis. This allows the flotation device to rotate more easily when sitting upon water or high-friction mineral sediments/slurries 8, ensuring the effective extension of the drainage conduit 5.
   iv. The flotation device 1 is asymmetrically weighted with two attached masses 2 with high specific gravity to ensure that extension of the drainage system occurs only as a result of water or sediment elevation increases, and not due to other environmental forces such as wind. The flotation device has a dense mass attached 2 as far from the rotational center of mass as practical. The mass can be cast into the body of the flotation device or connected using other means such as rivets or bolts. This mass creates a moment arm, or torque around the rotational axis which serves to resist the rotation of the flotation device from its resting position where the asymmetrical masses occupy the lowest portion of the flotation device relative to the water level. Only an opposed rotational force of greater magnitude can cause the device to rotate, releasing drainage conduit. The size of this counter-rotational force (controlled by the mass of the asymmetrical weighting and its distance from the rotational axis) is designed to allow rotation due to the buoyant force generated by the flotation device, but not due to other forces of lesser magnitude such as wind-induced rotational forces.
c. Drainage Conduit: a rope or similar tether system 5 with favorable hydrological characteristics that is connected at one end to the system anchor 6, and at the other wrapped around and connected at its end to the flotation device 1. The conduit must provide a path of lower hydraulic conductivity for water to flow along its length 10, from areas of relatively high pressure toward areas of relatively lower pressures. The drainage conduit must also be designed and constructed such that it incorporates a filter barrier 14, or is by its nature a filter barrier, which prevents fine mineral particles 12 from entering the drainage conduit. These particles could block the drainage conduit impacting its ability to serve as a low-resistance drainage pathway. When meeting these criteria, the drainage conduit can serve the purpose of accelerating the drainage of trapped interstitial water 9 by allowing it to flow into the drainage conduit where it can report to surface or another area of relatively lower pressure 11. This allows for the consolidation of said sediments 12 by removing some of the water volume between mineral particles. Drainage conduit 5 can be comprised of a variety of different material types and physical structures and sizes to provide optimal characteristics in different material types and environmental conditions. A drainage conduit could be comprised of different combinations of fibrous materials that exhibit the following properties:
   i. A core comprised of a material with significant cross-sectional voids which provides continuous drainage pathways along the conduit. This core would provide tensile strength to the conduit 13. Void space required would be a function of desired dewatering flow rates.
   ii. A sheath comprised of fine strands of tightly woven fibers, or similar filter cloth materials wrapped around the core. This sheath serves as a filter barrier, allowing water to access the drainage conduit, but blocking fine mineral sediments which could potentially cause the conduit to become blocked, reducing the hydraulic conductivity of the conduit 14.
   iii. Be supple enough to be rolled around the flotation device spool for long duration without developing weakness or excessive memory.
   iv. Be resistant to environmental stresses such as moisture, friction, sunlight, freezing, heat, and chemically inhospitable environments such as acidic or basic conditions.
An example of a suitable drainage conduit material is a pre-fabricated vertical wick drain, as is currently commercially available, and described in U.S. Pat. No. 4,622,138A and U.S. Pat. No. 5,820,296A. These drains are comprised of a semi-rigid core which creates a void space for water to flow through. This core is wrapped by a geotextile material which serves as the filter barrier as described previously. In current commercial use, these drains are installed from the surface downwards by heavy equipment (either pushing or drilling them downwards). In the passive tailings compactor, these drains would simply be employed as the drainage conduit/tether 5 which unwraps from a spool and extends upward with basin elevation.

### REFERENCE LIST FOR DRAWINGS

1. Flotation device
2. Asymmetrical weight
3. Air gap
4. Spool spindle
5. Drainage conduit
6. Anchor mass
7. Supernatant water surface
8. Mineral sediment surface
9. Pore water flow path in mineral sediments
10. Pore water flow path in drainage conduit
11. Pore water discharging from drainage conduit into supernatant pond or open atmosphere
12. Mineral particle
13. Core of drainage conduit
14. Filter barrier of drainage conduit
15. Flat anchor plate

1-6. (canceled)

7. A passive tailings compactor for installing and maintaining a vertical drainage pathway through tailings, comprising:
a drainage conduit which serves to enable the flow of water from the tailings while filtering and excluding solid particles;
an anchor attached to one end of the drainage conduit; and
a flotation device attached to the other end of the drainage conduit having a central axis about which a length of the drainage conduit is wrapped;
wherein the flotation device is asymmetrically weighted or shaped to resist rotation.

8. The passive tailings compactor of claim 7, wherein the relative net buoyancy of the flotation device is less than that of water, but higher than that of the tailings, thereby allowing the flotation device to remain submerged in water and still rest above the tailings.

9. The passive tailings compactor of claim 7, wherein the drainage conduit is a coarse rope material core wrapped with a geotextile filter cloth sheath.

10. The passive tailings compactor of claim 7, wherein the drainage conduit is a coarse rope material core wrapped with a sheath of tightly woven, fine nylon strands.

11. The passive tailings compactor of claim 7, wherein the drainage conduit is a pre-fabricated vertical wick drain.

12. The passive tailings compactor of claim 7, wherein the drainage conduit is a perforated tube core wrapped with a geotextile filter cloth sheath.

13. The passive tailings compactor of claim 7, wherein the drainage conduit is a perforated tube core wrapped with a sheath of tightly woven, fine nylon strands.

14. The passive tailings compactor of claim 7, wherein the anchor is a frictional stake.

15. The passive tailings compactor of claim 7, wherein the anchor is a plate having a large cross-sectional area.
